(19) United States
(12) Patent Application Publication
(10) Pub. No.: US 2007/0011222 A1
(43) Pub. Date: Jan. 11, 2007

(54) Floating-point processor for processing single-precision numbers

(76) Inventors: Sherman M. Dance, Rochester, MN (US); Jeffrey R. Summers, Raleigh, NC (US); Shivakumar Swaminathan, Morrisville, NC (US)

Correspondence Address: SAWYER LAW GROUP LLP, PO BOX 51418, PALO ALTO, CA, 94303, US

(21) Appl. No.: 11/178,073

(22) Filed: Jul. 7, 2005

(51) Int. Cl. G06F 7/00

(52) U.S. Cl. 708/603

(57) ABSTRACT

A system and method for processing single-precision floating-point numbers. The system includes a processor that has a double-precision (DP) register, wherein the DP register receives a plurality of single-precision (SP) operands, and a recoder coupled to the DP register, wherein the recoder recodes a first SP operand of the plurality of SP operands. The processor also includes a plurality of partial product (PP) units coupled to the DP register, wherein each PP unit of the plurality of PP units processes a second SP operand of the plurality of SP operands.

### FIELD OF THE INVENTION

The present invention relates to floating-point processing, and more particularly to a system and method for processing single-precision floating-point numbers.

### BACKGROUND OF THE INVENTION

Single-instruction multiple-data (SIMD) processors are well known. They are typically used to support both single-precision (SP) and double-precision (DP) floating-point multiplication operations to satisfy the requirements of many graphics applications. SIMD processors enable one instruction to perform the same operation on multiple data items. As such, what would typically require a repeated succession of instructions (i.e. a loop) can be performed in one instruction.

A problem with conventional SIMD processors is that they occupy a significant amount of physical space. Conventional SIMD processors have separate SP and DP data paths for executing SIMD instructions. Also, they consume a tremendous amount of power due to the additional hardware required for the data paths. These problems are worsened when SIMD processors are designed to process a large amount of data.

Accordingly, what is needed is an improved system and method for processing both SP and DP floating-point numbers. The system and method should be simple, cost effective, and capable of being easily adapted to existing technology. The present invention addresses such a need.

### SUMMARY OF THE INVENTION

A system and method for processing single-precision floating-point numbers is disclosed. The system includes a processor that has a double-precision (DP) register, wherein the DP register receives a plurality of single-precision (SP) operands, and a recoder coupled to the DP register, wherein the recoder recodes a first SP operand of the plurality of SP operands. The processor also includes a plurality of partial product (PP) units coupled to the DP register, wherein each PP unit of the plurality of PP units processes a second SP operand of the plurality of SP operands.

According to the method and system disclosed herein, the present invention provides savings in core area, enhances performance by reducing routing problems of operands to DP and SP pipelines, and provides power savings since only one set of registers is clocked for both DP and SP operations.

### BRIEF DESCRIPTION OF THE DRAWINGS

FIG. 1 is a block diagram of a floating-point processor in accordance with the present invention.

FIG. 2 is a flow chart showing a method for processing SP operands in accordance with the present invention.

FIG. 3 is a diagram showing the organization of data in a booth recoding register of the booth recoder of FIG. 1, in accordance with the present invention.

FIG. 4 is a diagram of a PP unit for formatting the multiplicands for the booth muxes 130 [14-25] of FIG. 1, in accordance with the present invention.

FIG. 5 is diagram of data organized in the adder of FIG. 1, in accordance with the present invention.

FIG. 6 is a diagram of a PP unit for formatting the multiplicands for the booth mux 130 [26] of FIG. 1, in accordance with the present invention.

FIG. 7 is a diagram of a PP unit for formatting the multiplicands for the booth muxes 130 [00-11] of FIG. 1, in accordance with the present invention.

FIG. 8 is a diagram of a PP unit for formatting the multiplicands for the booth muxes 130 [12] of FIG. 1, in accordance with the present invention.

### DETAILED DESCRIPTION OF THE INVENTION

The present invention relates to floating-point processing, and more particularly to a system and method for processing single-precision floating-point numbers. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiment shown, but is to be accorded the widest scope consistent with the principles and features described herein.

A processor for processing SP floating-point numbers is disclosed. The processor performs single-precision (SP) multiply operations using a double-precision (DP) design. The system includes a DP register receives an SP multiplier and an SP multiplicand, a recoder that recodes the SP multiplier, and a plurality of partial product (PP) units that processes the SP multiplicand. The processor also includes muxes corresponding with the PP units that generate PPs based on the recoded SP multiplier and the processed SP multiplicand. The processor also includes a Wallace-tree adder that sums the PPs. To more particularly describe the features of the present invention, refer now to the following description in conjunction with the accompanying figures.

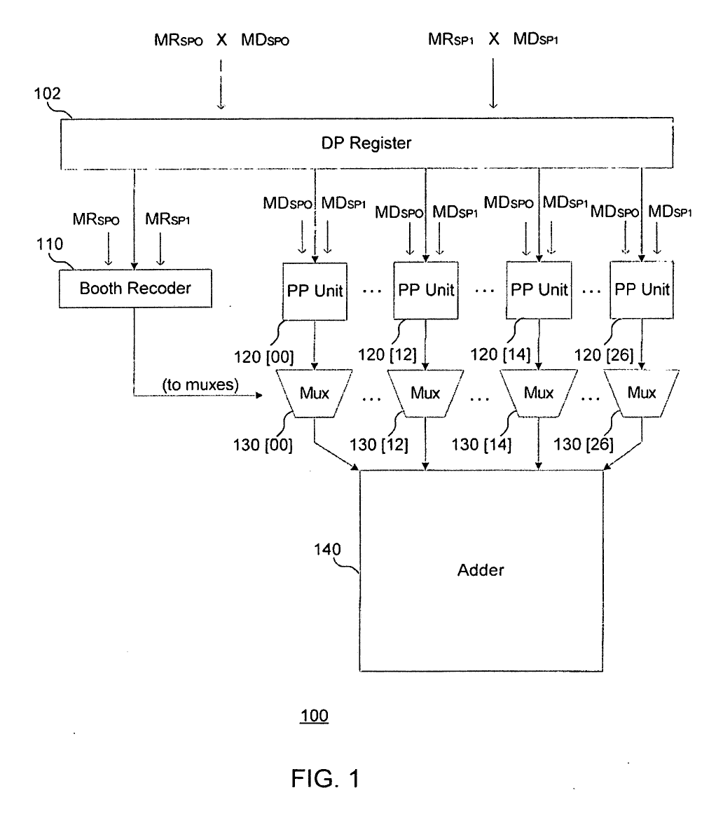

FIG. 1 is a block diagram of a floating-point processor 100 in accordance with the present invention. The floating-point processor 100, or “processor” 100 includes a DP register 102, a booth recoder 110, partial product (PP) units 120 [00-26], booth multiplexers, or “muxes” [00-26], and an adder 140, preferably a Wallace-tree adder. For ease of illustration, only the PP units 120 [00, 12, 14, and 26] and the booth muxes 130 , [00, 12, 14, and 26] are shown.

Although the present invention is described in the context of 27 PP units 120 [00-26] and 27 booth muxes 130 [00-26], one of ordinary skill in the art will readily recognize that there could be any number of PP units and booth muxes, and their use would be within the spirit and scope of the present invention.

The DP register 102 is a 64-bit register, which can receive both DP and SP operands. In accordance with the present invention, the DP register 102 receives two SP multiplier-multiplicand operand pairs MR_{SP0} and MP_{SP0}, and MR_{SP1} and MP_{SP1}. Since a DP mantissa is typically 53 bits and an SP mantissa is typically 24 bits, two SP mantissa are placed appropriately in a 53-bit DP format for booth recoding.

The booth recoder 110 is a DP booth recoder 110 that can receive both DP and SP operands. In accordance with the present invention, the booth recoder 110 receives both of the SP multipliers MR_{SP0} and MR_{SP1}.

In accordance with the present invention, the PP units can receive both DP and SP operands. As such, each of the PP units 120 [00-26] receives both of the multiplicands MD_{SP0} and MD_{SP1}. Each PP unit 120 [00-26] is associated with one booth mux 130 [00-26].

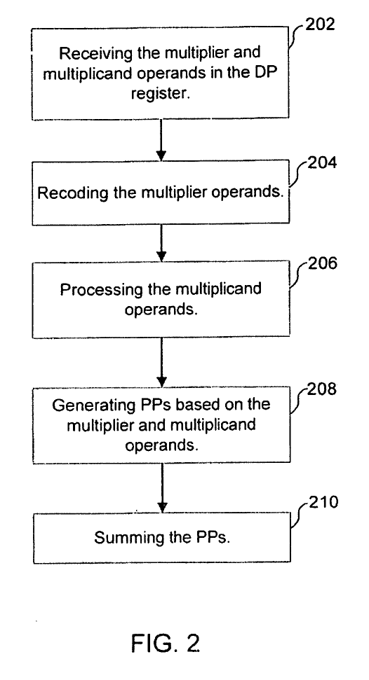

FIG. 2 is a flow chart showing a method for processing SP operands in accordance with the present invention. Referring to both FIGS. 1 and 2 together, the process begins in, a step 202, where the respective multipliers and multiplicands MR_{SP0} and MP_{SP0}, and MR_{SP1} and MP_{SP1} are received in the DP register 102.

Next, in a step 204, the multipliers are recoded. Specifically, the 53-bit data for the multiplier of an SP operation is formed by concatenating the 24-bit multiplier MR_{SP0}, a 4-bit multiplier shift (4′b0000), the 24-bit multiplier MR_{SP1}, and a 1-bit multiplier shift (1′b0). Radix-4 modified booth-recoding is used to recode the multiplier formed by this concatenation. In SP mode, the booth recoding in FIG. 1 is identical for both of the multipliers MR_{SP0} and MR_{SP1}.

Next, in a step 206, the multiplicands are processed in the PP units 120 [00-26]. Specifically, two 24-bit SP multiplicands MD_{SP0} and MD_{SP1} are placed appropriately in the 53-bit DP format. The PP units 120 [00-26] generate PP vectors, each of which can one of +2 MD, −2 MD, +1 MD, −1 MD, or 0 MD. These PP vectors are sent to the respective booth muxes 130 [00-26].

Special adjustment of the second SP multiplicand MD_{SP1} is done to align binary points of the two SP PPs to the ease the design of leading zero anticipators (LZA) for the results of the SP operations. Also, additional logic is used to handle the sign-extension of the DP/SP partial products and bogus carry elimination from the PP vectors.

Next, in a step 208, PPs based on the multiplier and multiplicand are generated at the booth muxes 130 [00-26]. Specifically, each booth mux 130 [00-26] receives PP vectors from its corresponding PP unit 120 [00-26] and receives selection data/bits generated from recoding the multipliers MR_{SP0} and MR_{SP1} from the booth recoder 110. The selection data selects the appropriate PP vector (e.g. +2 MD, −2 MD, +1 MD, −1 MD, or 0 MD). Based on the selection data, each booth mux outputs a PP that is based on the selected PP vector. Accordingly, 27 PPs are outputted since there are 27 booth muxes.

Next, in a step 210, the PPs are summed at the adder 140. As shown, the processor 100 executes two SP mantissa operations by placing the two 24-bit SP multipliers MR_{SP0} and MR_{SP1} and two 24-bit multiplicands MD_{SP0} and MD_{SP1} in the 53-bit double precision format. Accordingly, two SP multiplication operations are performed simultaneously using a DP design.

A benefit of the present invention is that it accommodates multiple data formats, i.e., both DP and SP operations. Both DP and SP operations can be performed in a single-piece of DP hardware. Furthermore, because only a single-piece of DP hardware is used, only one clock is required to operate the DP and SP operations.

Although the present invention is described in the context of two SP multiplier-multiplicand operand pairs MR_{SP0} and MP_{SP0}, and MR_{SP1} and MP_{SP1}, one of ordinary skill in the art will readily recognize that there could be any number of SP multiplier-multiplicand operand pairs (e.g. 1, 3, or more), and their use would be within the spirit and scope of the present invention.

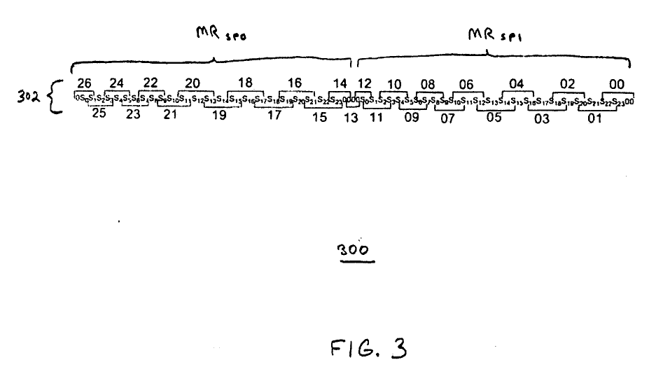

FIG. 3 is a diagram showing the organization of data in a booth recoding register 300 of the booth recoder 110 of FIG. 1, in accordance with the present invention. The booth recoder stores the two 24-bit SP multipliers MR_{SP0} and MR_{SP1}. The multipliers MR_{SP0} and MR_{SP1} are each divided into 13 groups 302 [14-26] and 302 [00-12], respectively. As shown, each group includes 3 bits, where each group shares one or two bits with another group. For example, the group 302 [25] includes bits S₁, S₂, and S₃, where bit S₁ is shared by the group 302 [26] and the group 302 [25]. In order for there to be enough bits so that each group has 3 bits, each of the multipliers MR_{SP0} and MR_{SP1} includes 24 bits plus 3 filler bits (also referred to as “bogus” or “padding” bits). Each filler bit is shown as a “0.” For example, the group 302 [26] includes bits 0 (filler bit), S₀, and S₁. There is an additional group 302 [13] that functions as a separator between the multipliers MR_{SP0} and MR_{SP1}.

Each group is associated with one booth mux. Accordingly, there are 27 groups 302 [00-26] and 27 corresponding booth muxes 130 [00-26]. The bits of each group are used to as selection data for selecting an appropriate PP vector at the respective booth mux 130 [00-26].

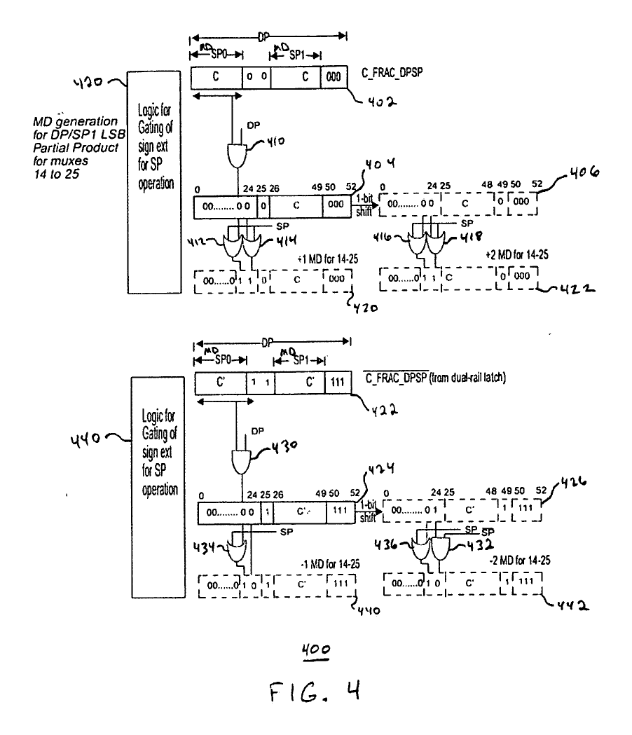

FIG. 4 is a diagram of a PP unit 400 for processing or formatting the multiplicands for the booth muxes 130 [14-25] of FIG. 1, in accordance with the present invention. The PP unit 400 includes registers 402, 404, and 406, an AND gate 410, OR gates 412, 414, 416, and 418, and logic 420. The combination of these elements function to generate PP vectors (i.e. +1 MD and +2 MD) for the booth muxes 130 [14-25].

The PP unit 400 also includes registers 422, 424, and 426, AND gates 430 and 432, OR gates 434 and 436, and logic 440. The combination of these elements also function to generate PP vectors (i.e., −1 MD and −2 MD) for the booth muxes 130 [14-25]. Note that elements to generate a PP vector 0 MD are not shown since the value would effectively be “0” if selected. Accordingly, the PP unit 400 generates modified 53-bit PP vectors (i.e. +2 MD, −2 MD, +1 MD, −1 MD, and 0 MD), one of which is selected at the respective booth mux 130 [14-25] for processing/compression in the Wallace tree adder 140.

Referring to the register 402, 53-bit data for the multiplicand of the SP operation is formed by concatenating the 24-bit multiplicand MD_{SP0}, a 2-bit multiplicand shift (2′b00), the 24-bit multiplicand MD_{SP1}, and a 3-bit multiplicand shift (3′b000). Accordingly, there is a total of 53 bits. These 53 bits and a DP status signal are inputted into the AND gate 410. The combination of a 1-bit shift of the multiplier MR_{SP1} and a 3-bit shift of the multiplicand MD_{SP1} provides a total 4-bit shift. The primary reason behind the extra 4-bit left shift of the multiplicand MD_{SP1} is to align the product binary points. This eases the leading zero anticipator (LZA) design for an SP operation in a DP pipeline.

In accordance with the present invention, one of the two multiplicands MD_{SP0} or MD_{SP1} are forced to zero and the other of the two multiplicands MD_{SP0} or MD_{SP1} is latched as an intermediate value. Accordingly, referring to the register 404, the multiplicand MD_{SP0} is forced to zero and the other multiplicand MD_{SP1} is latched in the register 404. The result is 1-bit shifted and latched in the register 406. The resulting +1 MD PP vector 420 and the +2 MD PP vector 422 are shown.

When generating a −1 MD PP vector and a −2 MD PP vector, the PP unit 400 operates similarly as when generating a +1 MD PP vector or a +2 MD PP vector, except that the value of the 53-bit multiplicand MD (combined MD_{SP0} and MD_{SP1}) in the register 422 is the inverse of the 53-bit multiplicand MD in the register 402. The resulting −1 MD PP vector 440 and the −2 MD PP vector 442 are shown.

Accordingly, the PP vectors are appropriately negated/shifted and can then be fed to the booth muxes for selection. The desired multiplication in an SIMD is MR spo X MD_{SP0} and MR_{SP0}, X MD_{SP1}. The additional logic 420 and 440 prevents multiplication of the operands MR_{SP0} and MD_{SP1} and prevents multiplication of the operands MR_{SP0} and MD_{SP1}. The formatting for the multiplicands MD_{SP0} and MD_{SP1}, as well as the formatting for the multipliers MR_{SP0} and MR_{SP1} enables a common (i.e. single) custom DP circuit to be used for the dynamic table logic for the two SP operands.

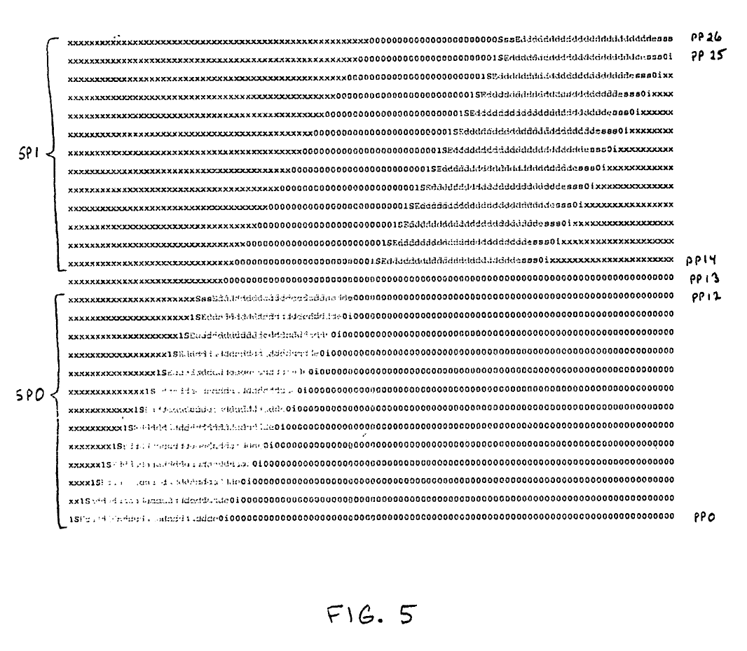

FIG. 5 is diagram of data organized in the adder 140 of FIG. 1, in accordance with the present invention. FIG. 5 illustrates partial products PPs [0-26] with sign extension bits in a DP Wallace-tree. Since the PP vector has 54 bits (53-bit mantissa+a filler bit “0” at the LSB for recoding), there are 27 PPs to be compressed. The top half represents the SP1 PPs [14-26] (resulting from the MR_{SP1} X MD_{SP1} operation), and the bottom half represent the SPO PPs [0-13] (resulting from the MR_{SP0} X MD_{SP0} operation).

Referring to both FIGS. 4 and 5 together, again, the PP unit 400 provides PP vectors to be selected (at the booth muxes 130 [14-25]) for the PPs [14-25]. Specifically referring to the +1 MD PP vector 420 and +2 MD PP vector 422 (FIG. 4), and PP [25] in the Wallace-tree adder (FIG. 5), the “11” (bit numbers 24 and 25) correspond to the “1S” in PP [25]. Note that an “s” represents a sign bit, and an “S” represents an inverted sign bit. An “e” represents an end data term (least significant bit (LSB)), and an “E” represents an end data term (most significant bit (MSB)). A “d” represents middle data, and a “D” represents middle data inverted. A “0” represents a logical zero, and a “1” represents a logical one. Finally, an “x” represents an unused bit, which is effectively a “0.”

There is additional logic (not shown) to generate the sign extension bits in the new positions for the PPs. Also, the LSB of the SP0 PP vectors feeding into the booth mux 130 [12] needs adjustment for DP/SP. Note that there is not any carryout from the right side to the left side. Otherwise, the SP0 PPs will be corrupted. The filler bit is at bit number 52 for the SP0 PPs and at bit number 106 for the SP1 PPs (numbering from 0-160 including upper addend positions). The PP 13 is an unused position, separating the SP0 and SP1 PPs.

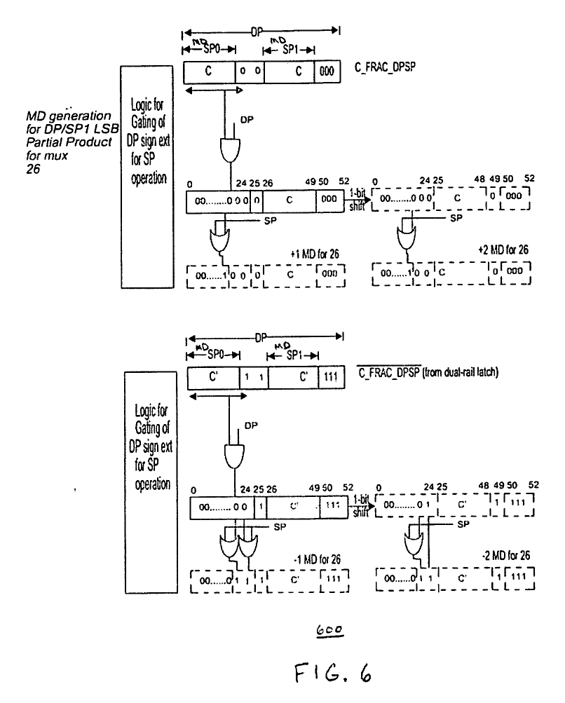

FIGS. 6-8 are diagrams of PP units for formatting the multiplicand for remaining booth muxes 130, and these PP units operate similarly to the PP unit of FIG. 5.

FIG. 6 is a diagram of a PP unit 600 for formatting the multiplicands for the booth mux 130 [26] of FIG. 1, in accordance with the present invention. Referring to both FIGS. 5 and 6 together, the PP unit 600 provides PP vectors to be selected (at the booth mux 130 [26]) for the PP 26.

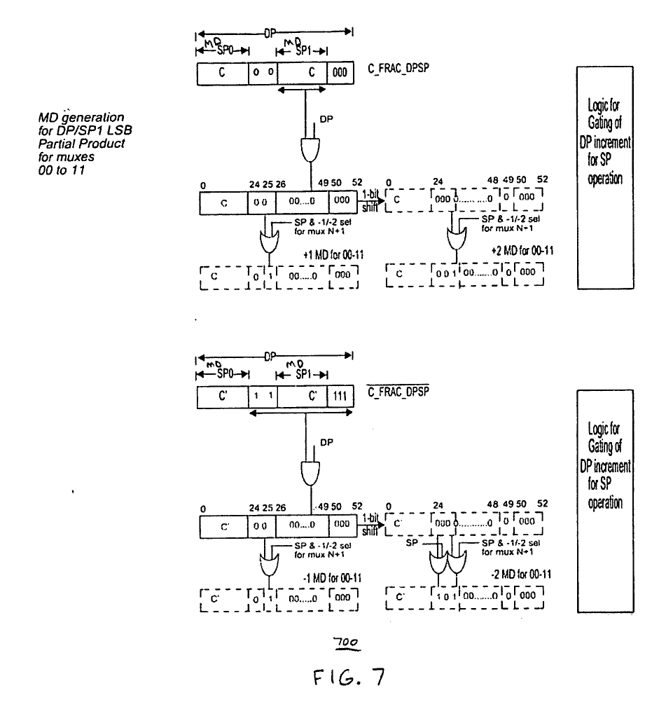

FIG. 7 is a diagram of a PP unit 700 for formatting the multiplicands for the booth muxes 130 [00-11] of FIG. 1, in accordance with the present invention. Referring to both FIGS. 5 and 7 together, again, the PP unit 700 provides PP vectors to be selected (at the booth muxes 130 [00-11]) for the PPs 00-11.

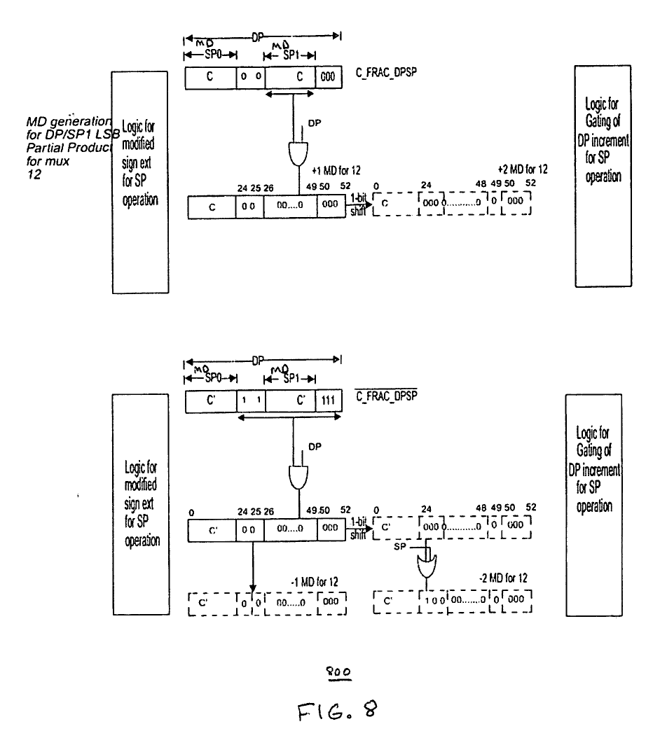

FIG. 8 is a diagram of a PP unit 800 for formatting the multiplicands for the booth muxes 130 [12] of FIG. 1, in accordance with the present invention. Referring to both FIGS. 5 and 8 together, again, the PP unit 800 provides PP vectors to be selected (at the booth muxes 130 [12]) for the PPs 12.

According to the system and method disclosed herein, the present invention provides numerous benefits. For example, it provides huge savings in core area, it enhances performance by reducing routing problems of operands to DP and SP pipelines, and it provides power savings since only one set of registers is clocked for both DP and SP operations.

A processor for processing SP floating-point numbers has been disclosed. The processor performs SP multiply operations using a DP design. The system includes a DP register that receives an SP multiplier and an SP multiplicand, a recoder that recodes the SP multiplier, and a plurality of partial product (PP) units that processes the SP multiplicand. The processor also includes muxes corresponding with the PP units that generate PPs based on the recoded SP multiplier and the processed SP multiplicand. The processor also includes a Wallace-tree adder that sums the PPs.

The present invention has been described in accordance with the embodiments shown. One of ordinary skill in the art will readily recognize that there could be variations to the embodiments, and that any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

What is claimed is:

1. A processor comprising:
a double-precision (DP) register, wherein the DP register receives a plurality of single-precision (SP) operands;
a recoder coupled to the DP register, wherein the recoder recodes a first SP operand of the plurality of SP operands; and
a plurality of partial product (PP) units coupled to the DP register, wherein each PP unit of the plurality of PP units processes a second SP operand of the plurality of SP operands.

2. The processor of claim 1 further comprising a plurality of muxes coupled to the plurality of partial product units, wherein each mux of the plurality of muxes generates a PP based on the first SP operand and the second SP operand.

3. The processor of claim 2 further comprising an adder coupled to the plurality of muxes, wherein the adder sums the PPs.

4. The processor of claim 3 wherein the recoder provides a plurality of selection bits for respective muxes of the plurality of muxes, and wherein the plurality of selection bits are based on the first SP operand.

5. The processor of claim 4 wherein the first SP operand comprises a first multiplier and a second multiplier.

6. The processor of claim 5 wherein the first multiplier, the second multiplier, and a plurality of filler bits are concatenated such that the first and second multipliers are compatible with DP hardware.

7. The processor of claim 5 wherein the first and second multipliers are 24-bit multipliers and the plurality of filler bits total 5 bits such that the first and second multipliers are compatible with 53-bit DP hardware.

8. The processor of claim 5 wherein the first and second multipliers are divided into groups, wherein each group corresponds to one mux of the plurality of muxes, and wherein each group provides one selection bit of the plurality of selection bits.

9. The processor of claim 2 wherein each PP unit of the plurality of PP units provides a plurality of PP vectors based on the second SP operand.

10. The processor of claim 9 wherein each PP unit of the plurality of PP units corresponds to one mux of the plurality of muxes.

11. The processor of claim 10 wherein one PP vector of the plurality of PP vectors is selected at the one corresponding mux based on the first SP operand.

12. The processor of claim 1 wherein the second SP operand comprises a first multiplicand and a second multiplicand.

13. The processor of claim 12 wherein the first multiplicand, the second multiplicand, and a plurality of filler bits are concatenated such that the first and second multiplicands are compatible with DP hardware.

14. The processor of claim 13 wherein the first and second multiplicands are 24-bit multiplicands and the plurality of filler bits total 5 bits such that the first and second multiplicands are compatible with 53-bit DP hardware.

15. The processor of claim 1 wherein each PP unit of the plurality of partial product (PP) units comprises:
a plurality of registers; and
a plurality of gates coupled to the plurality of registers, wherein the gates are adapted to receive DP and SP signals.

16. The processor of claim 3 wherein the adder is a Wallace-tree adder.

17. A processor comprising:
a double-precision (DP) register, wherein the DP register is adapted to receive a plurality of single-precision (SP) operands;
a recoder coupled to the DP register, wherein the recoder recodes a first SP operand of the plurality of SP operands;
a plurality of partial product (PP) units coupled to the DP register, wherein each PP unit of the plurality of PP units processes a second SP operand of the plurality of SP operands, wherein each PP unit of the plurality of PP units provides a plurality of PP vectors based on the second SP operand, and wherein each PP unit of the plurality of partial product (PP) units comprises:
a plurality of registers; and
a plurality of gates coupled to the plurality of registers, wherein the gates are adapted to receive DP and SP signals;
a plurality of muxes coupled to the plurality of partial product units, wherein each mux of the plurality of muxes generates a PP, and wherein the recoder provides a plurality of selection bits for respective muxes of the plurality of muxes, and wherein the plurality of selection bits are based on the first SP operand; and
an adder coupled to the plurality of muxes, wherein the adder sums the PPs, and wherein the processor performs SP multiply operations using DP hardware.

18. The processor of claim 17 wherein the first SP operand comprises a first multiplier and second multiplier.

19. The processor of claim 18 wherein the first multiplier, the second multiplier, and a plurality of filler bits are concatenated such that the first and second multipliers are compatible with DP hardware.

20. The processor of claim 18 wherein the first and second multipliers are 24-bit multipliers and the plurality of filler bits total 5 bits such that the first and second multipliers are compatible with 53-bit DP hardware.

21. The processor of claim 18 wherein the first and second multipliers are divided into groups, wherein each group corresponds to one mux of the plurality of muxes, and wherein each group provides one selection bit of the plurality of selection bits.

22. The processor of claim 17 wherein each PP unit of the plurality of PP units corresponds to one mux of the plurality of muxes.

23. The processor of claim 22 wherein one PP vector of the plurality of PP vectors is selected at the one corresponding mux based on the first SP operand.

24. The processor of claim 17 wherein the second SP operand comprises a first multiplicand and a second multiplicand.

25. The processor of claim 24 wherein the first multiplicand, the second multiplicand, and a plurality of filler bits are concatenated such that the first and second multiplicands are compatible with DP hardware.

26. The processor of claim 25 wherein the first and second multiplicands are 24-bit multiplicands and the plurality of filler bits total 5 bits such that the first and second multiplicands are compatible with 53-bit DP hardware.

27. The processor of claim 17 wherein the adder is a Wallace-tree adder.

28. A method for processing single-precision (SP) operands, the method comprising:
receiving the plurality of SP operands in a double-precision (DP) register;
recoding a first SP operand of the plurality of SP operands; and
processing a second SP operand of the plurality of SP operands.

29. The method of claim 28 wherein the first SP operand comprises a first multiplier and a second multiplier.

30. The method of claim 29 further comprising concatenating the first multiplier, the second multiplier, and a plurality of filler bits such that the first and second multipliers are compatible with DP hardware.

31. The method of claim 28 wherein the second SP operand comprises a first multiplicand and a second multiplicand.

32. The method of claim 29 further comprising concatenating the first multiplicand, the second multiplicand, and a plurality of filler bits such that the first and second multiplicands are compatible with DP hardware.

33. The method of claim 28 further comprising generating a plurality of partial products (PPs) based on the first SP operand and the second SP operand.

34. The method of claim 33 further comprising summing the PPs.

35. A computer readable medium containing program instructions for processing single-precision (SP) operands, the program instructions which when executed by a computer system cause the computer system to execute a method comprising:
receiving the plurality of SP operands in a double-precision (DP) register;
recoding a first SP operand of the plurality of SP operands; and
processing a second SP operand of the plurality of SP operands.

36. The method of claim 35 wherein the first SP operand comprises a first multiplier and a second multiplier.

37. The method of claim 36 further comprising program instructions for concatenating the first multiplier, the second multiplier, and a plurality of filler bits such that the first and second multipliers are compatible with DP hardware.

38. The computer readable medium of claim 35 wherein the second SP operand comprises a first multiplicand and a second multiplicand.

39. The computer readable medium of claim 36 wherein comprising program instructions for concatenating the first multiplicand, the second multiplicand, and a plurality of filler bits such that the first and second multiplicands are compatible with DP hardware.

40. The computer readable medium of claim 35 further comprising program instructions for generating a plurality of partial products (PPs) based on the first SP operand and the second SP operand.

41. The computer readable medium of claim 40 further comprising program instructions for summing the PPs.
